(19) United States
(12) Patent Application Publication
(10) Pub. No.: US 2007/0133520 A1
(43) Pub. Date: Jun. 14, 2007

(54) Dynamically adapting peer groups

(75) Inventors: Gopala Krishna R. Kakivaya, Sammamish, WA (US); Richard L. Hasha, Seattle, WA (US); Christopher G. Kaler, Sammamish, WA (US)

Correspondence Address: WORKMAN NYDEGGER/MICROSOFT, 1000 EAGLE GATE TOWER, 60 EAST SOUTH TEMPLE, SALT LAKE CITY, UT, 84111, US

(73) Assignee: Microsoft Corporation, Redmond, WA (US)

(21) Appl. No.: 11/301,745

(22) Filed: Dec. 12, 2005

(51) Int. Cl. H04L 12/66

(52) U.S. Cl. 370/352

(57) ABSTRACT

Communicating a message using between networked agents. Some embodiments may be practiced, for example, in a network including one or more interconnected agents. A method facilities communicating a message to one or more of the interconnected agents. The method includes receiving feedback including information about the network. The information about the network is tracked. The method further includes consulting a set of policy rules. The policy rules include logic which takes into account the tracked information about the network. The policy rules further include information about how messages should be sent based on the logic which takes into account the tracked information about the network. The method also includes sending the message according to the information about how messages should be sent.

### BACKGROUND

Background and Relevant Art

Modern computers often include functionality for connecting to other computers. For example, a modern home computer may include a modem for dial-up connection to internet service provider servers, email servers, directly to other computers, etc. In addition, nearly all home computers come equipped with a network interface port such as an RJ-45 Ethernet port complying with IEE 802.3 standards. This network port, as well as other connections such as various wireless and hardwired connections can be used to interconnect computers.

Computers can be interconnected in various topologies. For example, one topology is a client-server topology. In a client server topology, a central authority maintains control over the network organization. The central authority can provide routing functionality by providing network addresses to clients on the network. When the central authority becomes disabled or non-functional, network communications can be hampered or completely disabled.

Another type of topology is a peer-to-peer network. Peer-to-peer networks are formed as a self selected group assembled for a purpose. The peers in a peer-to-peer network can identify network members by providing and examining tokens, sharing a common encryption or key, running a common application, and the like.

In one example of peer group communications, each peer in a peer group is aware of a subset of all of the peers in the peer group. If a peer decides to send a message, the peer will send the message to all of the peers of which it is aware. Each of those peers will send the message to the peers of which they are aware. In this fashion, messages are flooded to the peer group. Flooding often creates large network traffic and can overload network resources.

Messages can be multiplexed over different channels on a network. Typically, an application uses a common channel for different purposes. An application can multiplex messages at the application layer.

The subject matter claimed herein is not limited to embodiments that solve any disadvantages or that operate only in environments such as those described above. Rather, this background is only provided to illustrate one exemplary technology area where some embodiments described herein may be practiced.

### BRIEF SUMMARY

One embodiment described herein includes a method of communicating a message. The method may be practiced, for example, in a network including one or more interconnected agents. The method facilities communicating a message to one or more of the interconnected agents. The method includes receiving feedback including information about the network. The information about the network is tracked. The method further includes consulting a set of policy rules. The policy rules include logic which takes into account the tracked information about the network. The policy rules further include information about how messages should be sent based on the logic which takes into account the tracked information about the network. The method also includes sending the message according to the information about how messages should be sent.

In another embodiment, a method of communicating a message to one or more interconnected agents on a network includes receiving router feedback including information about routers on the network. The method further includes selecting one or more routers to send the message based on a set of router policy rules and the router feedback. The method also includes receiving channel feedback including information about channels on the network. The message is sent on one or more selected channels based on a set of channel policy rules and the channel feedback.

Yet another embodiment includes a system to transfer messages on a network between one or more interconnected agents. The system includes a feedback manager configured to provide information about the network. The system further includes a routing policy manager configured to receive the information about the network. A set of policy rules is coupled to the routing policy manager. The policy rules include logic which takes into account the information about the network and includes information about how messages should be sent based on the logic, which takes into account the information about the network. The system includes one or more communication mechanisms selectable by the routing policy manager to send the message according to the policy rules as applied to the feedback information.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

Additional features and advantages will be set forth in the description which follows, and in part will be obvious from the description, or may be learned by the practice of the teachings herein. Features and advantages of the invention may be realized and obtained by means of the instruments and combinations particularly pointed out in the appended claims. Features of the present invention will become more fully apparent from the following description and appended claims, or may be learned by the practice of the invention as set forth hereinafter.

### BRIEF DESCRIPTION OF THE DRAWINGS

In order to describe the manner in which the above-recited and other advantages and features can be obtained, a more particular description of the subject matter briefly described above will be rendered by reference to specific embodiments which are illustrated in the appended drawings. Understanding that these drawings depict only typical embodiments and are not therefore to be considered to be limiting in scope, embodiments will be described and explained with additional specificity and detail through the use of the accompanying drawings in which:

FIG. 1 illustrates a system illustrating components of one exemplary embodiment;

FIG. 2 illustrates a method of sending messages between interconnected agents; and

FIG. 3 illustrates another method of sending messages between interconnected agents.

### DETAILED DESCRIPTION

Embodiments herein may comprise a special purpose or general-purpose computer including various computer hardware, as discussed in greater detail below.

One embodiment described herein facilitates routing messages between agents through communication mechanisms. Communication mechanisms can be selected by applying logic in policy rules to feedback information which contains information about the communication mechanisms. For example, one category of communication mechanisms is routers. Such routers include, for example and not limited to, direct flooding, peer routing, relay clients, firewall proxies, multicasting, or shared memory. The feedback manager can gather information about the routers and provide the information to a routing policy manager. The routing policy manager may be connected to a number of policy rules. The policy rules can be applied to feedback information about the routers. This allows the policy routing manager to select one or more appropriate routers for transferring messages between agents.

In one embodiment, the communication mechanisms may be channels. The channels may include, for example, named pipes such as TCP, http, UDP, SMTP, and POP. In one alternative embodiment, the channels may be one or more peer groups to which agents belong where the peer groups facilitate transferring of certain types of messages. The feedback manager may provide information about the channels to a routing policy manager. As described previously, the information may be applied to policy rules and allow the policy manager to select appropriate channels based on the feedback information and the policy rules.

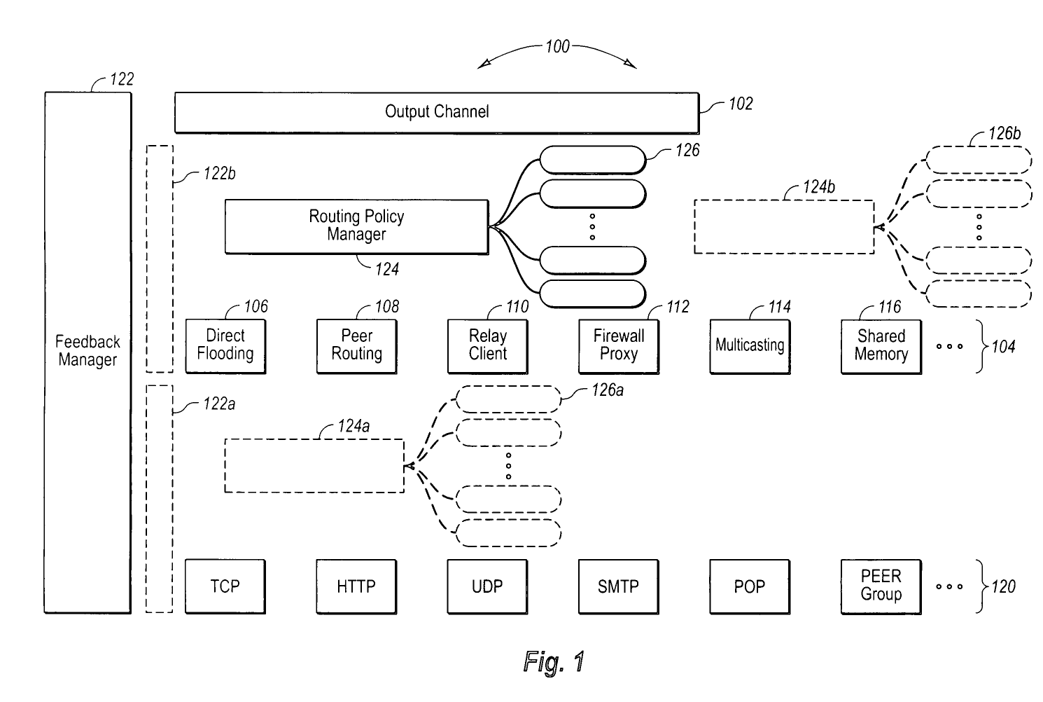

Referring now to FIG. 1 a system 100 to transfer messages on a network between one or more interconnected agents is shown. An agent may be for example but not limited to host computers, operating systems, frameworks, application code etc. The system 100 includes an output channel 102 that may be configured to connect to an application for receiving messages from the application. Notably, input channels can optionally participate for example by filtering messages already seen, etc. The application delivers messages to the output channel 102 for delivery to other agents. The system 100 further comprises one or more communication mechanisms. The communication mechanisms may include routers 104. Exemplary routers shown in FIG. 1 include direct flooding 106 peer routing 108 relay clients 110 firewall proxies 112 multicasting 114 or shared memory 116. The examples shown in FIG. 1 are purely exemplary and not exhaustive of routers that may be used. Notably, peer-to-peer agents may make use of the system 100 shown in FIG. 1. As illustrated in FIG. 1, one router is a direct flooding router 106. Direct flooding 106 allows messages to be flooded to a peer group to allow the messages to reach other peers that are members of the peer group. Additionally other peer routing 108 is illustrated in FIG. 1. Notably, even when a peer-to-peer configuration is used, other routing mechanisms may be used. As will be described in more detail below, one or more routers 104 may be used to transfer a message from an application. A message may be transferred using more than one router if it is efficient, or for other reasons, to reach intended recipients of the message.

Communication mechanisms can also include channels 120. After one or more routers 104 have been selected, the routers 104 in turn use one or more channels 120 to send messages. Exemplary channels may be TCP, http, UDP, SMTP, POP, etc. As noted above the system 100 may be used in a peer-to-peer environments. Thus, in one exemplary embodiment, the channels 120 may be peer groups. An agent using the system 100 may belong to one or more peer groups where the agent sends messages using the peer groups acting as channels 120.

The system 100 includes a feedback manager 122 configured to provide information about the network, messages on the network, participants on the network, etc. Information about the network may include for example information related to the routers 104 including network configuration and status, failed/successful connections, neighbors, etc. Information about the network may include alternatively or in addition to that noted above, information about the channels 120. for example, the information may include information related to the locality of participation, the number of known or estimated participants on a channel, security semantics, quality of service requirements, time-of-day, network congestion, size of messages, frequency of messages, channel policies, etc . . . .

The system 100 shown in FIG. 1 further includes a routing policy manager 122 configured to receive the information about the network from the feedback manager 120. A set of policy rules 124 are coupled to the routing policy manager 122. The policy rules 124 may include logic which takes into account the information about the network from the feedback manager 120. The policy rules 124 may include information about how messages should be sent based on the logic which takes into account the information about the network from the feedback manager 120. One or more communication mechanisms are selected by the routing policy manager to send the message according to the policy rules as applied to the feedback information. The policy rules 124 may be expressed, for example, as specified code, CLR/Java objects or script.

While the example shown in FIG. 1 illustrates a routing policy manager 124 and feedback manager 122 and rules 126 used to direct messages for all communication mechanisms including the routers 104 and channels 120, other alternative embodiments may implement a finer granularity of routing policy management and feedback management. For example a channels feedback manager 122a may be used in conjunction with a channels routing policy manager 124a and channel policy rules 126a. A separate router policy feedback manager 122b, router routing policy manager 124b and router policy rules 126b may be used to facilitate message transfers. For example, the router routing policy manager 124b may be used in conjunction with the router policy rules 126b and the router feedback manager 122b to appropriately select a router 104. Similarly the channels routing policy manager 124a may be used with channels policy rules 126a and channels feedback manager 122a to select one or more appropriate channels 120.

One embodiment may include a method of communicating a message to one or more of the interconnected agents. The method may be practiced, for example, in a network including one or more interconnected agents. The method includes an act of receiving feedback including information about the network (act 202). The information about the network may includes information such as network configuration, network status, failed connections, successful connections, neighbors, channels available on the network, location of peers in a peer group, and routers available on the network.

As described previously, and with reference to FIG. 1, channels 120 available on the network may be for example TCP, http, UDP, SMPTP, and POP protocols. Additionally, as mentioned previously, one embodiment may be used where peer groups are used as channels 120. An agent may belong to one or more peer groups for peer to peer networking. Each peer groups that an agent belongs to can be used as a channel 120 for transferring messages. Notably, embodiments may be implemented where one or more channels are used to transfer messages. If a message is intended for a number of different recipients, where different channels may be used to optimize delivery for different recipients, then embodiments herein contemplate the ability to optimize message delivery using different channels for different recipients. In other words, one or more channels may be used to transfer a message.

Routers 104 available on the network may be for example, one or more of direct flooding 106, peer routing 108, a relay client 110, a firewall proxy 112, multicasting 114, or shared memory 116. As explained previously, one embodiment may be used with peer to peer communications. In these and other embodiments, direct flooding 106 and/or peer routing 108 may be used as routers 104 for a message to be transferred. Notably, embodiments may include configurations where interconnected agents reside on the same host machine. Thus, transferring a message may be accomplished by using a relay that is shared memory. In this case, a memory pointer can be may be transferred between agents to send the message.

One or more routers 104 may be selected for use. For example, if efficiencies can be obtained by using different routers 104 for a message directed to different recipients, then the message may be sent using different routers 104 for the same message to different recipients. Specifically, direct flooding 106 may be used to transfer messages to agents connected at a common hub, while the same message may be transferred to agents across a firewall through a firewall proxy 1 12.

Receiving feedback (act 202) may include receiving a packaged message. For example, feedback information may be included in protocol messages. Messages sent through channels 120 or using routers 104 may be packaged to include feedback information such as the feedback information described above, or other feedback information. In one embodiment, feedback information may be packaged in a SOAP message as part of a Web Services embodiment. Web Services is a standardized way of integrating applications. Standardized XML documents can be used with SOAP (Simple Object Access Protocol) messages and WSDL (Web Services Description Language) descriptions to integrate applications without an extensive knowledge of the applications being integrated.

The method 200 further includes an act of tracking the information about the network (act 204). Tracking information about the network (act 204) may include maintaining or logging the information. This can provide an indication of network conditions over a period of time. Tracking information about the network (act 204) does not require maintaining the information about network conditions, but may include maintaining the information about network conditions in some embodiments. Tracking information about the network (act 204) may simply include handling of a single instance of a single network condition.

The method 200 further includes an act of consulting a set of policy rules (act 206). The policy rules 126 may include logic which takes into account the tracked information about the network. The policy rules 126 may further include information about how messages should be sent based on the logic. The logic takes into account the tracked information about the network.

In one exemplary embodiment, the set of policy rules 126 may include rules that specify a preference of protocols, a preference of routing mechanisms, or a priority. For example, one policy rule 126 may specify that certain protocols are preferred over other protocols. When preferred protocols are available, they will be used to transfer messages, subject to any other policy rules 126 that may be in effect.

In another example, one exemplary policy rule 126 may specify a priority. For example, one priority may specify that messages sent on a slower transport are sent prior to those sent on a faster transport. This may be done to compensate for transport speed differences such that messages arrive at destination agents more closely together than might otherwise be accomplished.

Policy rules may be implemented to facilitate automatic multiplexing at the channels. This may be accomplished by specifying criteria such as locality of participation, the number of known or estimated participants, security semantics, quality of service requirements, policy, time of day, network congestion, size of messages, frequency of messages, etc. In one exemplary embodiment feedback rules 126 and the feedback manager 122 may be used by input channels to detect for example, duplicate messages and discard them.

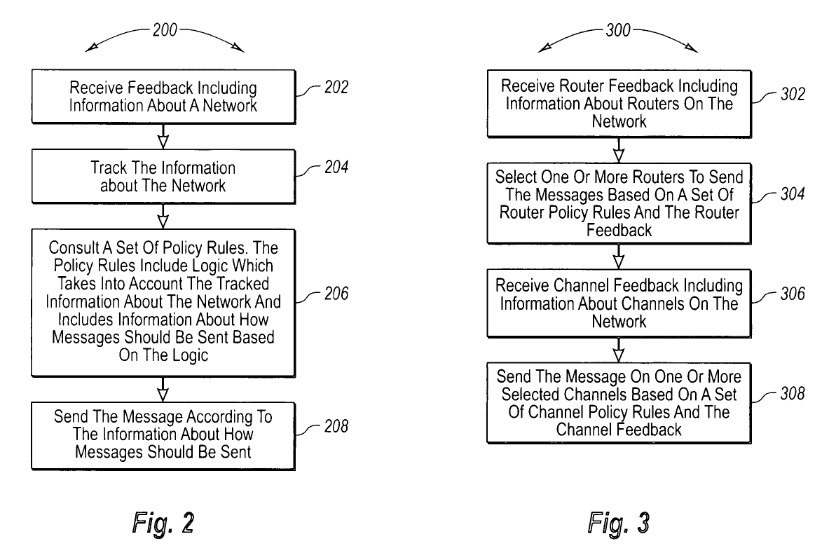

Returning again to FIG. 2, the method 200 further includes an act of sending the message according to the information about how messages should be sent (act 208). As alluded to previously herein, sending the message according to the information about how messages should be sent (act 208) may include sending the message on one or more routers.

The method 200 illustrated in FIG. 2 may further include hiding channel 120 from an application such that the method 200 is transparent to the application. Often, applications are involved in selecting channels 120 for multiplexing purposes. However, in one embodiment, logical channels may be presented to the application that are different than the actual physical channels 120 available. Thus, the routing policy manager 124 can select the physical channels 120 to be used while the application selects logical channels. Thus, the channels 120 are hidden from the application, such that the use of the routing policy manger is transparent to the application. This allows some embodiments to be used with applications that may not have been specifically designed for use with the systems and methods disclosed herein.

Referring now to FIG. 3, an alternate method of communicating messages to one or more interconnected agents 300 is illustrated. The method 300 may be practiced in a network environment including one or more interconnected agents. The method 300 may include an act of receiving router feedback including information about routers on the network (act 302). As described previously, the routers 104 may include at least one of direct flooding 106, peer routing 108, a relay client 110, a firewall proxy 112, multicasting 114, or shared memory 116.

The method 300 further includes selecting one or more routers to send the message based on a set of router policy rules and the router feedback (act 304)

The method 300 further includes receiving channel feedback including information about channels on the network (act 306). As noted previously herein, the channels may include one or more peer groups. Various other alternative embodiments contemplate the channels including one or more of TCP, HTTP, UDP, SMPTP, and POP.

The method 300 also includes sending the message on one or more selected channels based on a set of channel policy rules and the channel feedback.

Embodiments may also include computer-readable media for carrying or having computer-executable instructions or data structures stored thereon. Such computer-readable media can be any available media that can be accessed by a general purpose or special purpose computer. By way of example, and not limitation, such computer-readable media can comprise RAM, ROM, EEPROM, CD-ROM or other optical disk storage, magnetic disk storage or other magnetic storage devices, or any other medium which can be used to carry or store desired program code means in the form of computer-executable instructions or data structures and which can be accessed by a general purpose or special purpose computer. When information is transferred or provided over a network or another communications connection (either hardwired, wireless, or a combination of hardwired or wireless) to a computer, the computer properly views the connection as a computer-readable medium. Thus, any such connection is properly termed a computer-readable medium. Combinations of the above should also be included within the scope of computer-readable media.

Computer-executable instructions comprise, for example, instructions and data which cause a general purpose computer, special purpose computer, or special purpose processing device to perform a certain function or group of functions. Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. In a network including one or more interconnected agents, a method of communicating a message to one or more of the interconnected agents, the method comprising:
receiving feedback including information about the network;
tracking the information about the network;
consulting a set of policy rules, the policy rules including logic which takes into account the tracked information about the network and including information about how messages should be sent based on the logic which takes into account the tracked information about the network; and
sending the message according to the information about how messages should be sent.

2. The method of claim 1, wherein the information about the network includes at least one of network configuration, network status, failed connections, successful connections, neighbors, channels available on the network, location of peers in a peer group, and/or routers available on the network.

3. The method of claim 1, wherein the information about the network includes at least one of messages sent, messages seen, and/or member information.

4. The method of claim 2, wherein the channels available on the network include at least one of TCP, HTTP, UDP, SMPTP, and/or POP.

5. The method of claim 2, wherein the routers available on the network include at least one of direct flooding, peer routing, a relay client, a firewall proxy, multicasting, and/or shared memory.

6. The method of claim 1, wherein the set of policy rules includes rules that specify at least one of a preference of protocols, a preference of routing mechanisms, a priority congestion, transmission time, error/fault rates, associated parties, estimated recipients, and/or topology.

7. The method of claim 1, wherein the set of policy rules are specified as at least one of XML, binary, text, script and/or code.

8. The method of claim 1, wherein the set of policy rules facilitates automatic multiplexing by specifying criteria for at least one of locality of participation, the number of known or estimated participants, security semantics, quality of service requirements, policy, time of day, network congestion, size of messages, and/or frequency of messages.

9. The method of claim 1, wherein the set of policy rules includes one or more rules that specify a priority, the priority specifying that messages sent on a slower transport are sent prior to those sent on a faster transport to compensate for transport speed differences.

10. The method of claim 1, further comprising hiding channels from an application such that the method is transparent to the application.

11. The method of claim 1, wherein receiving feedback comprises receiving a SOAP message

12. The method of claim 1, wherein receiving feedback comprises receiving feedback from output channels.

13. The method of claim 1, wherein receiving feedback comprises receiving feedback from input channels.

14. In a network including one or more interconnected agents, a method of communicating a message to one or more of the interconnected agents, the method comprising:
receiving router feedback including information about routers on the network;
selecting one or more recipients to send the message based on a set of router policy riles and the router feedback;
receiving channel feedback including information about channels on the network; and
sending the message on one or more selected channels based on a set of channel policy rules and the channel feedback.

15. The method of claim 14, wherein the recipients include routers including at least one of direct flooding, peer routing, a relay client, a firewall proxy, multicasting, and/or shared memory.

16. The method of claim 14, wherein the channels include at least one peer group.

17. The method of claim 14, wherein the channels include at least one of TCP, HTTP, UDP, SMPTP, and/or POP.

18. A computer-readable medium having computer executable instructions for performing the acts recited in claim 14.

19. A system to transferring messages on a network between one or more interconnected agents, the system comprising:
a feedback manager configured to provide information about the network;
a routing policy manager configured to receive the information about the network;
set of policy rules coupled to the routing policy manager, the policy rules including logic which takes into account the information about the network and including information about how messages should be sent based on the logic which takes into account the information about the network; and
one or more communication mechanisms selectable by the routing policy manager to send the message according to the policy rules as applied to the feedback information.

20. The system of claim 19, wherein the routing policy manager is comprised of a router routing policy manager to select routers and a channel routing policy manager to select channels.
